(19) United States
(12) Patent Application Publication
(10) Pub. No.: US 2006/0082661 A1
(43) Pub. Date: Apr. 20, 2006

(54) Method of controlling digital photographing apparatus for classification reproduction and digital photographing apparatus using the method

(75) Inventors: Byoung-kyu Lee, Seongnam-si (KR); Byoung-hoon Yoon, Seongnam-si (KR); Ji-hong Kim, Seongnam-si (KR); Yun-cheal Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/072,718

(22) Filed: Mar. 3, 2005

(30) Foreign Application Priority Data
Oct. 15, 2004 (KR) 10-2004-0082559

(51) Int. Cl. H04N 5/76

(52) U.S. Cl. 348/231.2

(57) ABSTRACT

Provided is a method of controlling a digital photographing apparatus by which user files obtained as a result of performing a photographing operation in a photographing mode are stored in a storage medium and reproduced in a reproducing mode. The method includes changing particular characters at a particular position in names of the user files to characters selected by a user in the reproducing mode, and selecting and displaying only the user files having names that include a character selected by the user out of the particular characters at the particular position on a display panel of the digital photographing apparatus in the reproducing mode.

### CROSS-REFERENCE TO RELATED PATENT APPLICATIONS

This application claims the priority of Korean Patent Application No. 10-2004-0082559, filed on Oct. 15, 2004, in the Korean Intellectual Property Office, the disclosure of which is incorporated herein in its entirety by reference.

### BACKGROUND OF THE INVENTION

1. Field of the Invention

The present invention relates generally to a digital photographing apparatus, and more particularly to a method of controlling a digital photographing apparatus in which user files obtained as a result of performing a photographing operation in a photographing mode are stored and classified in a storage medium, and a digital photographing apparatus using the method.

2. Description of the Related Art

One example of a conventional digital photographing apparatus is disclosed in U.S. Patent Publication No. 20040119876 entitled “Method of Notification of Inadequate Picture Quality”. The disclosed digital photographing apparatus stores user files obtained as a result of a photographing operation in a storage medium when the apparatus is set in a photographing mode and reproduces the user files from the storage medium when the apparatus is set in a reproducing mode.

Since such foregoing apparatuses store a plurality of user files (e.g., hundreds or thousands of files), it may be difficult for a user to retrieve one or more user files of interest from the plurality of stored files. Therefore, in view of the foregoing, a digital photographing apparatus that can classify stored user files would be welcomed.

### SUMMARY OF THE INVENTION

The present invention provides a method of controlling a digital photographing apparatus by which a user can classify and store user files obtained as a result of performing a photographing operation to help a user find one or more stored files in a storage medium of the digital photographing apparatus.

According to an aspect of the present invention, there is provided a method of controlling a digital photographing apparatus by which user files obtained as a result of performing a photographing operation in a photographing mode are stored in a storage medium and reproduced in a reproducing mode. The method includes changing particular characters at a particular position in names of the user files to characters selected by a user in the reproducing mode; and selecting and displaying only the user files having names that include a character selected by the user out of the particular characters at the particular position on a display panel of the digital photographing apparatus in the reproducing mode.

The method enables a user to easily classify and store user files using particular characters, and therefore display only the classified and stored user files. Therefore, the user can easily find a file in the digital photographing apparatus itself.

According to another aspect of the present invention, there is provided a digital photographing apparatus using the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and the top of a digital camera according to the present invention;

FIG. 2 is a perspective view illustrating the back and the top of the digital camera of FIG. 1;

FIG. 3 is a block diagram of the digital camera of FIG. 1;

FIG. 4 is a flowchart illustrating a main algorithm of a digital camera processor (DCP) illustrated in FIG. 3;

FIG. 5 is a flowchart illustrating a preview mode algorithm illustrated in FIG. 4;

FIG. 6 is a flowchart illustrating a photographing mode algorithm illustrated in FIG. 4;

FIG. 7 is a block diagram of user files obtained as a result of performing the photographing mode illustrated in FIG. 4;

FIG. 8 is a block diagram of the user files having a first character of their names changed to particular characters selected by a user as a result of performing a reproducing mode illustrated in FIG. 4;

FIG. 9 is a flowchart illustrating the reproducing mode algorithm illustrated in FIG. 4;

FIG. 10 is a screen displayed on a color LCD panel after performing operation S91 illustrated in FIG. 9;

FIG. 11 is a flowchart illustrating a non-classification mode algorithm of FIG. 9;

FIG. 12 is a screen displayed on the color LCD panel after performing operation S931 illustrated in FIG. 11;

FIG. 13 is a flowchart illustrating the non-classification marking mode algorithm of FIG. 11;

FIG. 14A is a screen displayed on the color LCD panel as a result of performing operation S1303 of FIG. 13;

FIG. 14B is a screen displayed on the color LCD panel as a result of performing operation S1306 of FIG. 13;

FIG. 14C is a screen displayed on the color LCD panel as a result of performing operation S1310 of FIG. 13;

FIG. 15A is a screen displayed on the color LCD panel as a result of performing operation S1311 of FIG. 13;

FIG. 15B is a screen displayed on the color LCD panel as a result of performing operation S1313 of FIG. 13;

FIG. 16A is a screen displayed on the color LCD panel as a result of performing operation S1304 of FIG. 13;

FIG. 16B is a screen displayed on the color LCD panel as a result of performing operation S1316 of FIG. 13;

FIG. 16C is a screen displayed on the color LCD panel as a result of performing operation S1320 of FIG. 13;

FIG. 17 is a flowchart illustrating a classification mode algorithm of FIG. 9;

FIG. 18 is a screen displayed on the color LCD panel as a result of performing operation S943 of FIG. 17; and

FIG. 19 is a flowchart illustrating a classification marking mode algorithm of FIG. 17.

### DETAILED DESCRIPTION OF THE INVENTION

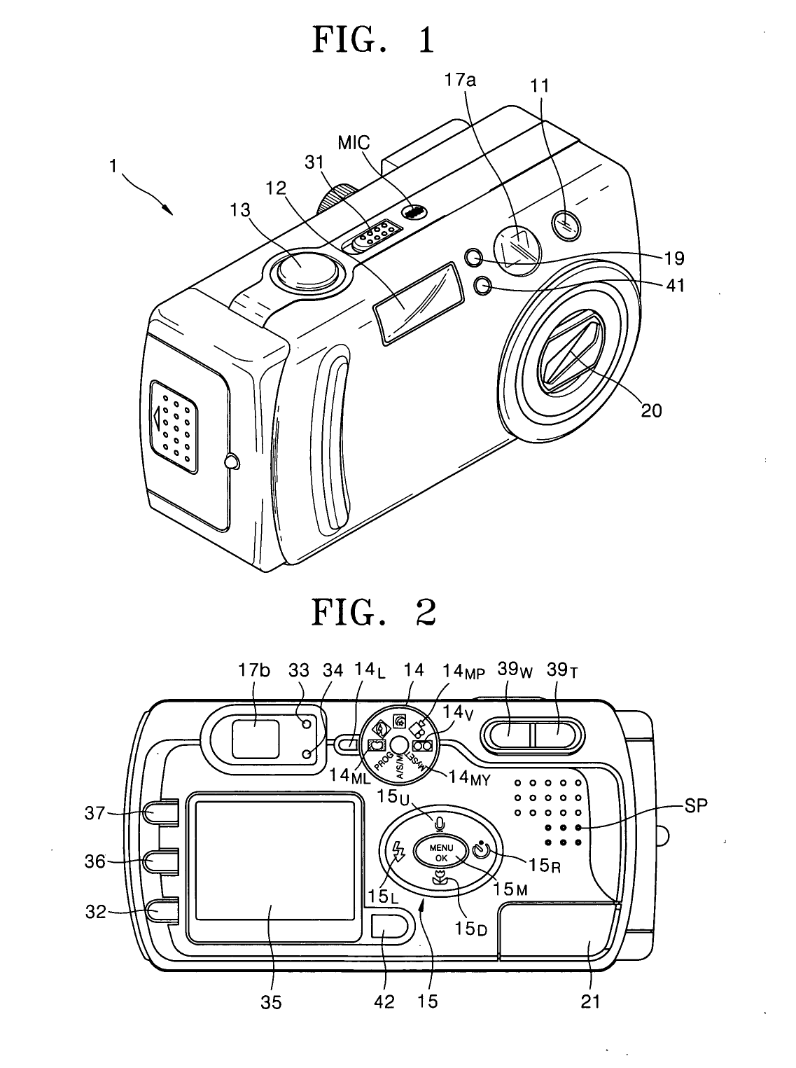

Referring to FIG. 1, the front part of a digital camera 1 according to one embodiment of the present invention includes a microphone MIC, a self-timer lamp 11, a flash 12, a shutter release button 13, a viewfinder 17a, a flash light intensity sensor 19, a power switch 31, a lens unit 20, and a remote receiver 41.

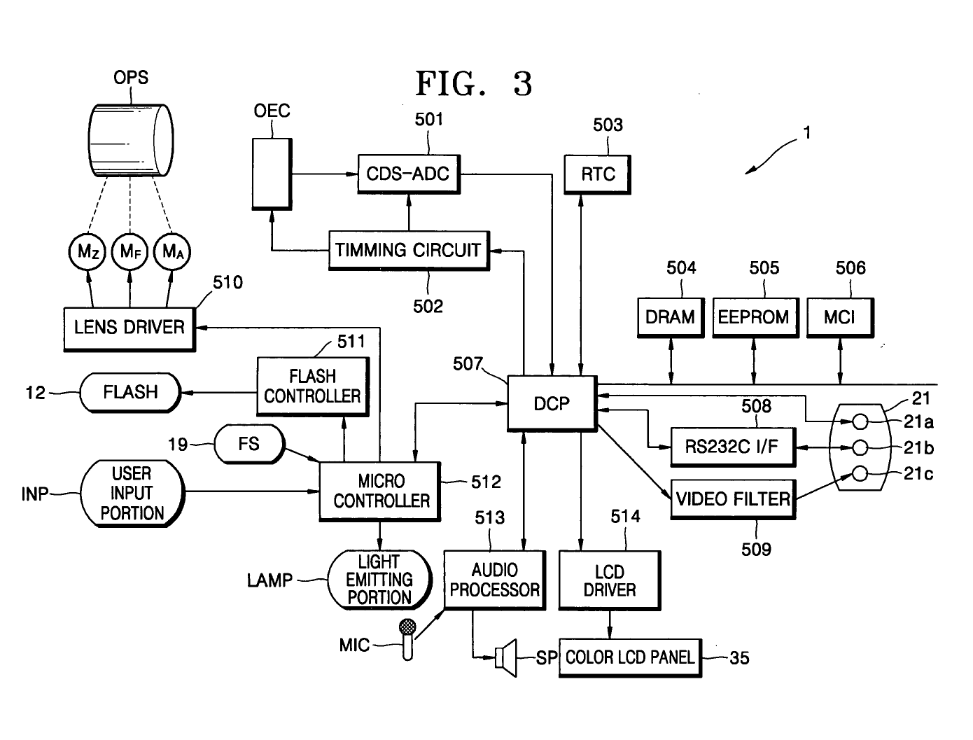

In a self-timer mode, the self-timer lamp 11 operates for a set period of time from the time when the shutter release button 13 is pressed to the time when an image starts to be captured. When the flash 12 operates, the flash light intensity sensor 19 senses the intensity of the light generated by the flash 12 and relays the sensed intensity of the light to a digital camera processor (DCP) 507 of FIG. 3 via a micro-controller 512 of FIG. 3. The remote receiver 41 receives command signals, for example, a photographing command signal, from a remote controller (not shown) and relays the photographing command signal to the DCP 507 via the micro-controller 512.

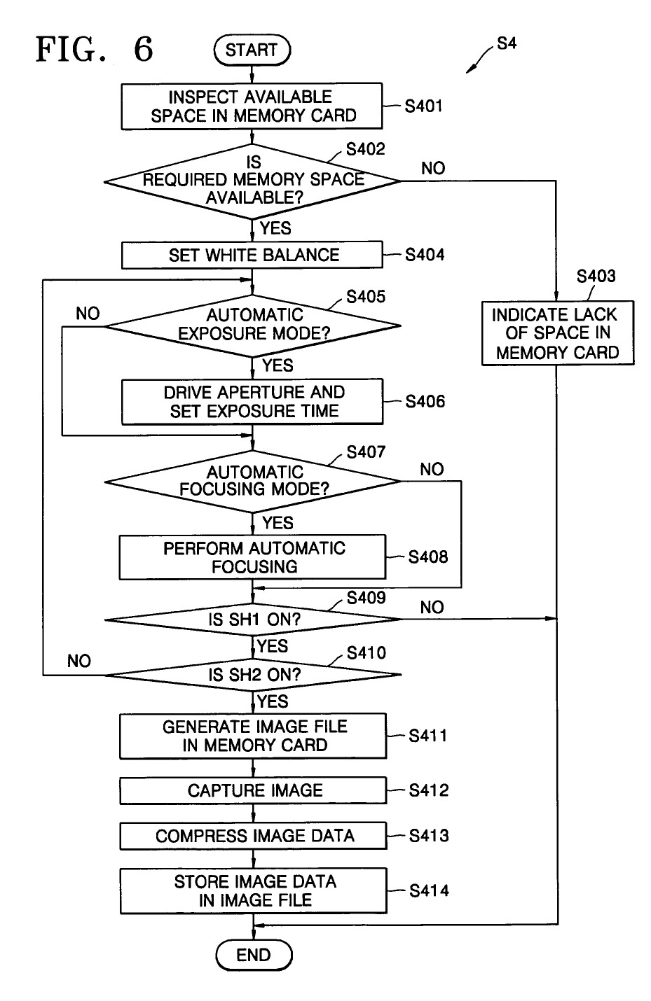

The shutter release button 13 has two levels. When a user first depresses the shutter release button 13 to a first level, a first level signal SH1 from the shutter release button 13 is turned on. When the user further depresses the shutter release button 13 to a second level, a second level signal SH2 of the shutter release button 13 is turned on (see FIG. 6).

Referring to FIG. 2, the back of the digital camera 1 includes a mode dial 14, functional buttons 15, a manual focus/delete button 36, a manual adjust/reproduce/terminate button 37, a reproduction mode button 42, a speaker SP, a monitor button 32, an automatic focusing lamp 33, a viewfinder 17b, a flash standby lamp 34, a color LCD panel 35, the wide angle-zoom button 3W_{Z}, the telephoto-zoom button 39_{T}, and an external interface unit 21.

The mode dial 14 is used for selecting any one of the operating modes of the digital camera 1 such as a simple photographing mode, a program photographing mode, a character photographing mode, a night view photographing mode, a manual photographing mode, a moving-image photographing mode 14_{MP}, a user setting mode 14_{MY}, and a recording mode 14_{V}.

The user setting mode 14_{MY} is an operating mode where the user decides the photograph-taking settings for each photographing mode. The recording mode 14_{V} is for recording only sounds, for example, a user's voice. After selecting the recording mode 14_{V}, when a user presses the shutter release button 13, an audio file is created in the memory card and audio data is stored in the audio file. When the user presses the shutter release button 13 again, the audio data stops being stored and the audio file is set.

The functional buttons 15 are used for operating specific functions of the digital camera 1 and the functional buttons 15 are also used as control buttons to manage the movement of an active cursor on the menu screen of the color LCD panel 35. Each of the functional buttons 15 will now be described in detail.

In a reproducing mode, if an image currently displayed is not enlarged, when the user presses a flash/left button 15_{L}, a next file in a reverse direction is displayed. If the image currently displayed is enlarged, when the user presses the flash/left button 15_{L}, the display region of the enlarged image is moved to the left.

In a preview mode, if the user presses the flash/left button 15_{L}, any one of the flash modes for a photographing mode is set.

In the reproducing mode, if the image currently displayed is enlarged, when the user presses a macro/down button 15_{D}, the display region of the enlarged image is moved up. In the preview mode, the user may set automatic proximity focusing by pressing a macro/down button 15_{D}.

In the reproducing mode, when the image currently displayed is enlarged, if the user presses a voice-memo/up button 15_{U}, the display region of the enlarged image is moved down. In the preview mode, if the user presses the voice/memo/up button 15_{U}, a 10 second recording is possible upon consecutive photographing.

In a setting mode from the preview mode, if the user presses a menu/select-confirm button 15_{M} when the active cursor is on a selection menu, the operation corresponding to the selection menu is performed.

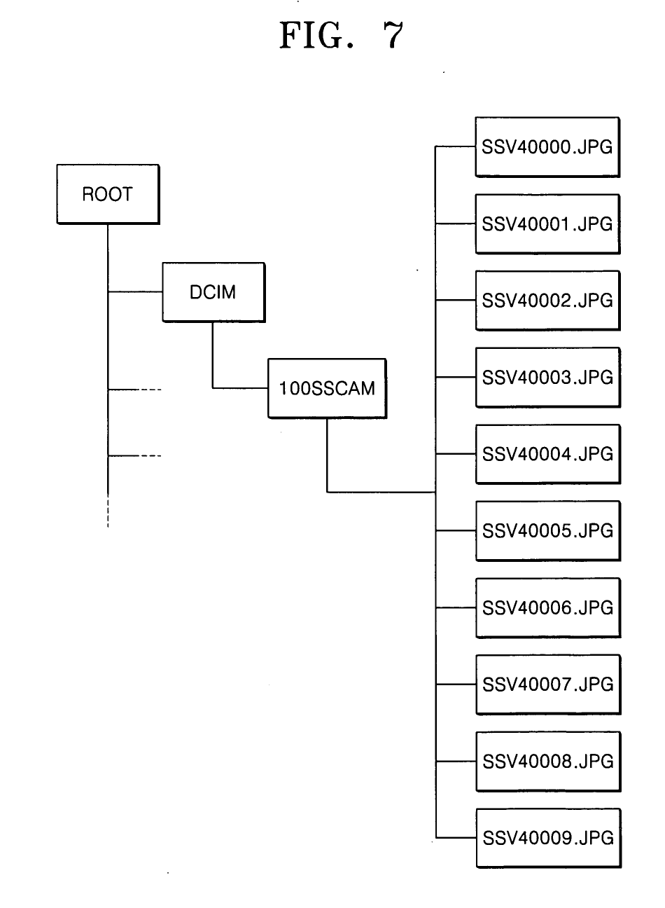

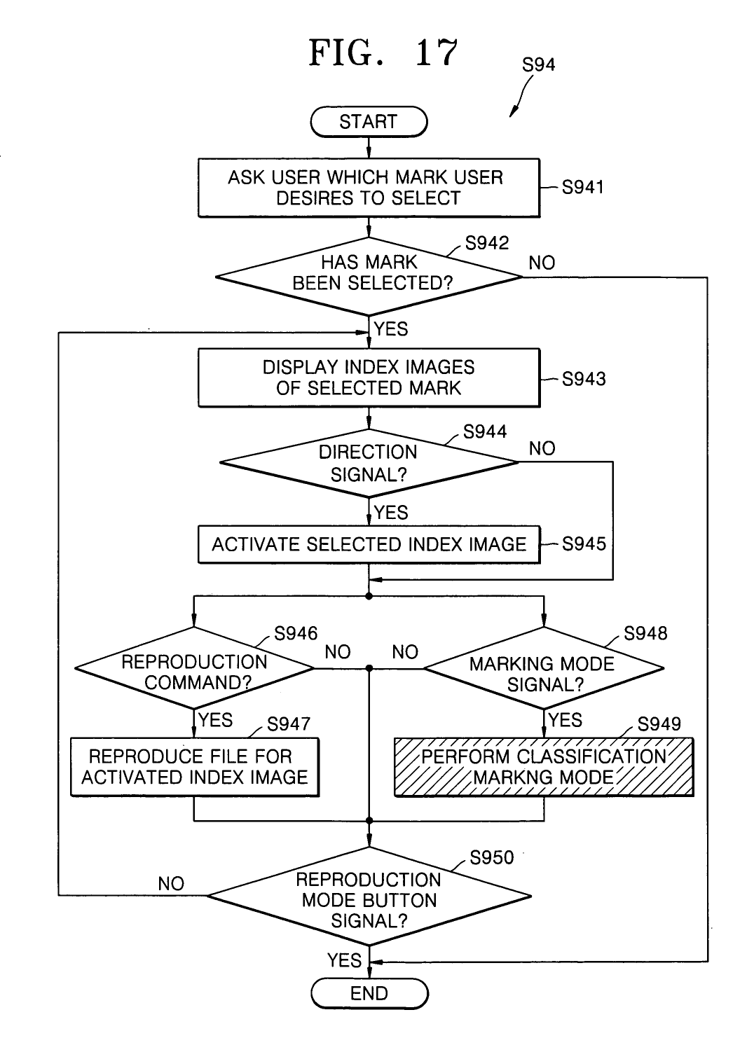

In the reproducing mode, if the user presses the menu/select-confirm button 15_{M} twice in a row, signals related to marking modes corresponding to classifications of user files (operation S937 of FIG. 11 or S949 of FIG. 17) are generated. An operation of the digital camera 1 in relation to the classification of the user files will be described in detail later with reference to FIGS. 7 through 19.

The manual adjust/reproduce/terminate button 37 is used for manual adjustment of specific conditions. In the reproducing mode, when the user presses the manual adjust/reproduce/terminate button 37, a selected moving-image file may be reproduced or its reproduction may be terminated.

The manual focus/delete button 36 is used for manual focusing or deleting in the photographing mode.

The monitor button 32 is used for controlling the operation of the color LCD panel 35. For example, in the photographing mode, when the user presses the monitor button 32, an image and photographing information are displayed on the color LCD panel 35. When the user presses the monitor button 32 again, the color LCD panel 35 is turned off. In the reproducing mode, when the user presses the monitor button 32 while an image file is being reproduced, photographing information about the image file is displayed on the color LCD panel 35. When the user presses the monitor button 32 again, only images are displayed.

The reproduction mode button 42 is used for switching between the reproducing mode and the preview mode.

The automatic focusing lamp 33 operates when a focus is well adjusted. The flash standby lamp 34 operates when the flash 12 of FIG. 1 is in a standby mode. A mode indicating lamp 14_{L} indicates a selection mode of the mode dial 14.

FIG. 3 is a block diagram illustrating various components of the digital camera 1 of FIGS. 1 and 2. The configuration and operation of the digital camera 1 will now be described with reference to FIGS. 1 through 3.

An optical system (OPS) including the lens unit 20 and a filter unit optically processes light. The lens unit 20 of the OPS includes a zoom lens, a focus lens, and a compensation lens.

When the user presses the wide angle-zoom button 39_{W} or the telephoto-zoom button 39_{T} included in a user input portion (INP), a signal corresponding to the wide angle-zoom button 39_{W} or the telephoto-zoom button 39_{T} is relayed to the micro-controller 512. The micro-controller 512 controls a lens driver 510, thereby running a zoom motor M_{Z}, which in turn, moves the zoom lens. In other words, when the user presses the wide angle-zoom button 39_{W}, the focus length of the zoom lens becomes short, thereby widening the angle of view. When the user presses the telephoto-zoom button 39_{T}, the focus length of the zoom lens becomes long, thereby narrowing the angle of view. Since the position of the focus lens is adjusted in a state where the position of the zoom lens is set, the angle of view is hardly affected by the position of the focus lens.

In the automatic focusing mode, a main controller built into the DCP 507 controls the lens driver 510 through the micro-controller 512, thereby driving a focus motor M_{F}. When the focus lens is moved to focus an image of a subject, for example, according to when a high frequency component of an image signal is maximally set, the position of the focus lens is known or reported to the DCP 507, for example, based on a number of driving steps of the focus motor M_{F} needed to maximize the high frequency component.

The compensation lens in the lens unit 20 of the OPS is not separately operated because the compensation lens compensates for the entire refractive index. Reference numeral M_{A} indicates a motor for driving an aperture (not shown).

An optical low pass filter included in the filter unit of the OPS eliminates high frequency optical noise. An infrared cut filter included in the filter unit of the OPS blocks the infrared component of incident light.

A photoelectric conversion unit (OEC) of a charge coupled device or a complementary metal oxide (CMOS) semiconductor converts light from the OPS into an analog electrical signal. Here, the DCP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise, adjusts amplitude, and then converts the analog signal into a digital signal.

A real time clock (RTC) 503 provides time information to the DCP 507. The DCP 507 processes the digital signal from the CDS-ADC 501 and generates a digital image composed of luminance and chromaticity values.

A light emitting portion (LAMP) is operated by the micro-controller 512 in response to a control signal generated by the DCP 507 including the main controller. The light emitting portion (LAMP) includes the self-timer lamp 11, the automatic focusing lamp 33, the mode indicating lamp 14_{L}, and the flash standby lamp 34. The INP includes the shutter release button 13, the mode dial 14, the functional buttons 15, the monitor button 32, the manual focus/delete button 36, the manual adjust/reproduce/terminate button 37, the wide angle-zoom button 39_{W}, and the telephoto-zoom button 39_{T}.

A dynamic random access memory (DRAM) 504 temporarily stores a digital image signal from the DCP 507. An electrically erasable and programmable read only memory (EEPROM) 505 stores algorithms and setting data. A user's memory card is inserted or removed in a memory card interface 506. The digital image signal from the DCP 507 is input to an LCD driver 514, thereby displaying an image on the color LCD panel 35.

The digital image signal from the DCP 507 can be transmitted via a universal serial bus (USB) connector 21a or via an RS232C interface 508 and an RS232C connector 21b for serial communications. The digital image signal from the DCP 507 can also be transmitted via a video filter 509 and a video output unit 21c as a video signal.

An audio processor 513 can relay sound from the microphone MIC to the DCP 507 or to speaker SP. In addition, the audio processor 513 can output an audio signal from the DCP 507 to the speaker SP. The micro-controller 512 controls the operation of a flash controller 511 in response to a signal from the flash light intensity sensor 19, thereby driving the flash 12.

A main algorithm of the DCP 507 of FIG. 3 will be now described with reference to FIGS. 1 through 4.

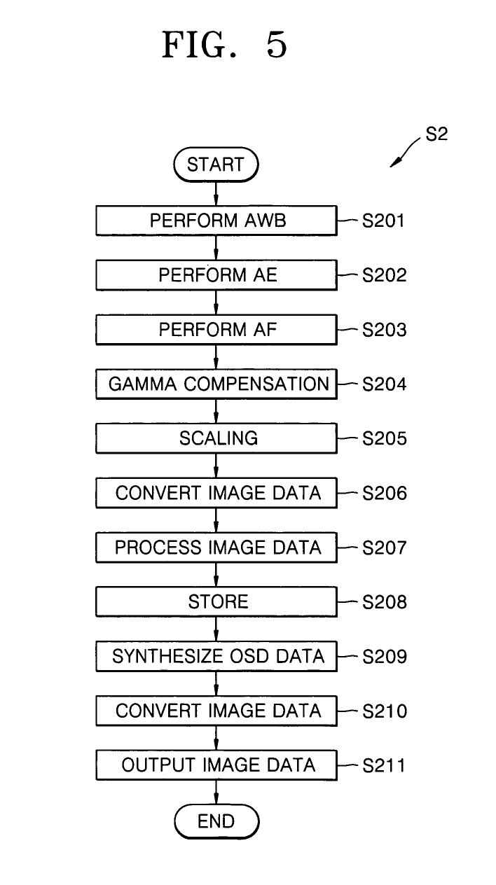

When power is applied to the digital camera 1, the DCP 507 is initialized (S1). After the initialization (S1), the DCP 507 performs a preview mode (S2). In the preview mode, an image input (i.e., an image seen by the lens unit 20 or viewfinder 17a) is displayed on the color LCD panel 35 as a preview to photographing the image. An operation related to the preview mode will be described in detail later with reference to FIG. 5.

When the first level signal SH1 from the shutter release button 13 is on after a user pressed the shutter release button 13 to the first level (S3), the DCP 507 operates according to a current photographing mode (S4). The photographing mode (S4) algorithm will be described further with reference to FIG. 6.

When signals generated from the INP that correspond to a setting mode are input to the DCP 507 (S5), the setting mode for setting an operating condition in response to the input signals from the INP is performed (S6).

When a termination signal is not generated, the DCP 507 continues to perform the following operation (S7).

When a signal is generated by the reproduction mode button 42 in the INP (S8), a reproducing mode is performed (S9). In the reproducing mode, reproducing is performed in response to input signals from the INP. The reproducing mode (S9) algorithm will be described later with reference to FIGS. 7 through 9. When the reproducing mode is terminated, the above operations are repeated.

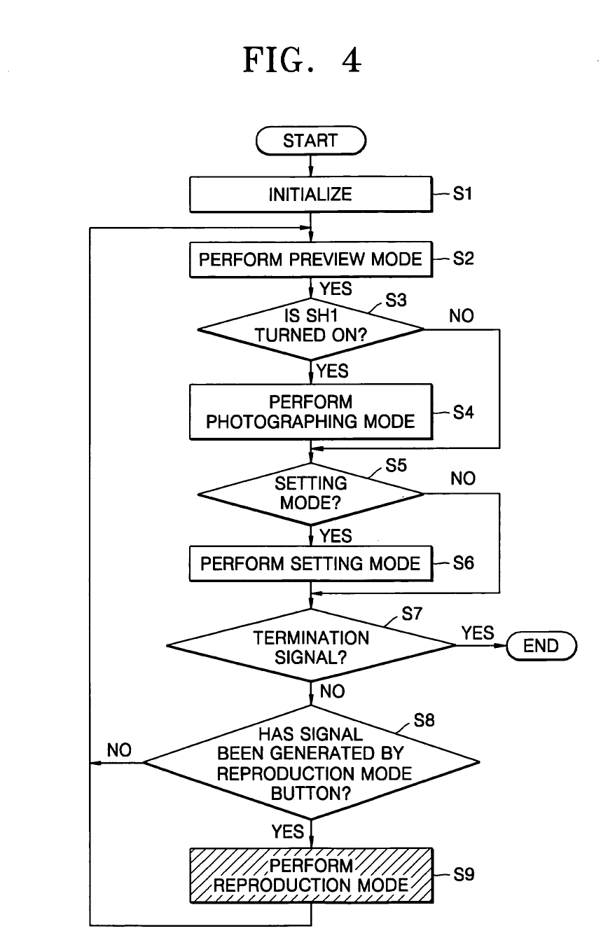

The preview mode (S2) algorithm of FIG. 4 will now be described with reference to FIGS. 1 through 3 and FIG. 5.

The DCP 507 performs automatic white balancing (AWB) and sets parameters related to the white balance (S201). In the automatic exposure mode (S202), the DCP 507 calculates the exposure by, for example, measuring incident luminance and driving the aperture driving motor M_{A} according to the calculated exposure, and sets a shutter speed. The DCP 507 then performs automatic focusing (S203).

The DCP 507 performs gamma correction on input image data (S204) and scales the gamma corrected image data to meet display standards (S205). The DCP 507 converts the scaled input image data from an RGB (red, green, and blue) format into a luminance-chrominance format (S206). The DCP 507 processes the input image data depending on resolution and display location, and filters the input image data (S207).

The DCP 507 temporarily stores the input image data (i.e., continually changing, for example, streaming, image data from which a still image is captured) in the DRAM 504 of FIG. 3 (S208). The DCP 507 synthesizes (i.e., combines) the data temporarily stored in the DRAM 504 of FIG. 3 with on-screen display (OSD) data (S209) relative to the image data (e.g., image resolution, etc.) The DCP 507 converts the combined OSD and image data from the RGB format into the luminance-chromaticity format (S210) and outputs the combined data in the converted format via the LCD driver 514 of FIG. 3 (S211).

FIG. 6 is a flowchart illustrating the photographing mode (S4) algorithm illustrated in FIG. 4. The photographing mode (S4) algorithm will now be described with reference to FIGS. 1 through 3 and FIG. 6. Here, the present position of the zoom lens is already set.

The DCP 507 inspects (S401) the remaining capacity of the memory card and determines (S402) whether the memory card has enough capacity to store a digital image signal. If the memory card does not have enough storage capacity, the DCP 507 indicates the lack of capacity of the memory card and ends the photographing mode (S403). If the memory card has enough storage capacity, the following operations are performed.

The DCP 507 sets white balance and parameters related to the white balance according to a present photographing condition (S404). In the automatic exposure mode (S405), the DCP 507 calculates the exposure by measuring incident luminance, drives the aperture driving motor MA according to the calculated exposure, and sets the exposure time (S406). In the automatic focusing mode (S407), the DCP 507 performs automatic focusing and drives the focus lens (S408).

When the first level signal SH1 from the shutter release button 13 is on (S409), the DCP 507 continues to perform the following operations.

The DCP 507 identifies whether the second level signal SH2 is on (S410). When the second level signal SH2 is not on, it means that the user did not press the shutter release button 13 to the second level to take a photograph, and the DCP 507 repeats the operations S405 through S410.

However, when the second level signal SH2 is on, it means that the user pressed the shutter release button 13 to the second level and the DCP 507 creates an image file (S411) in the memory card. Next, the DCP 507 captures an image (S412). In other words, the DCP 507 receives still-image data from the CDS-ADC 501 and the DCP 507 compresses the received still-image data (S413). The DCP 507 then stores the compressed still-image data in the image file (S414).

FIG. 7 is a block diagram illustrating an example file hierarchy of a plurality of user (i.e., image) files, which are obtained as a result of performing the photographing mode (S4 of FIG. 4), stored in the camera 1. Referring now to FIG. 7, a top-level/main file directory is shown at the top left of the figure as the directory “ROOT”. A “DCIM” directory and a “100SSCAM” sub-directory are shown under the “ROOT” directory, with the “100SSCAM” sub-directory storing a plurality of files.

As shown, the “OOSSCAM” sub-directory stores ten user files named SSV40000.JPG through SSV40009.JPG. As can be appreciated, the name of each of the user files is composed of 8 alphanumeric characters, which are selected or assigned according to a naming convention setting or rule. As illustrated, the file names are sequential according to a chronological order of the respective photographing operations, with the first four characters being fixed and the remaining four numbers being incremented by a predetermined value, herein 1, compared to the immediately proceeding file. Thus, the earlier-taken images have a lower file name (e.g., SSV40000.JPG), whereas the later-taken images have a higher file name (e.g., SSV40009.JPG).

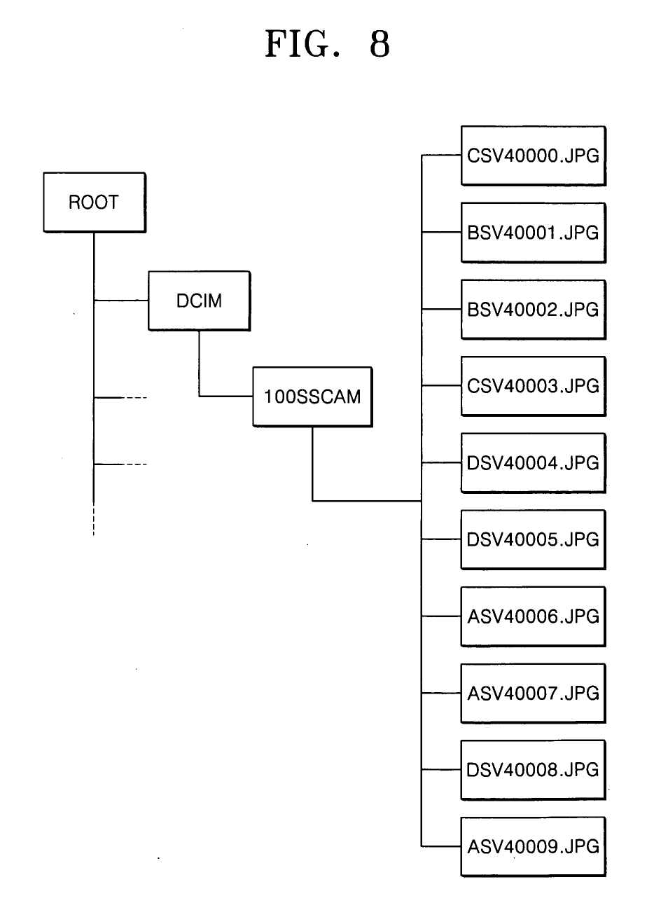

FIG. 8 is another block diagram illustrating an example file hierarchy according to an aspect of the invention wherein the user files each have a first character of their names changed to a particular character selected by the user, for example, as a result of performing the reproducing mode S9 of FIG. 4. By comparing FIGS. 7 and 8, one can appreciate that each file name's first character is changed to one character of a subset of predetermined characters, herein A through D. Thus, by changing a file name, a camera user may more easily find a file and further may group, categorize, classify or associate two or more files of the plurality. Further, fewer or additional characters may be employed. Moreover, other alphanumeric characters, symbols or indicia may be used instead of the illustrated characters A through D.

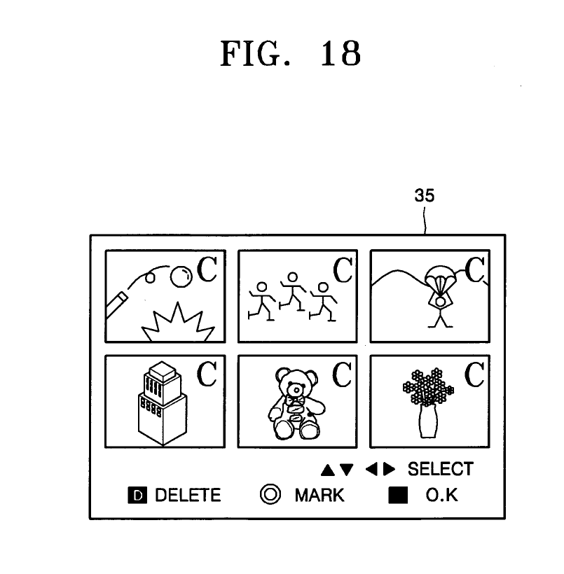

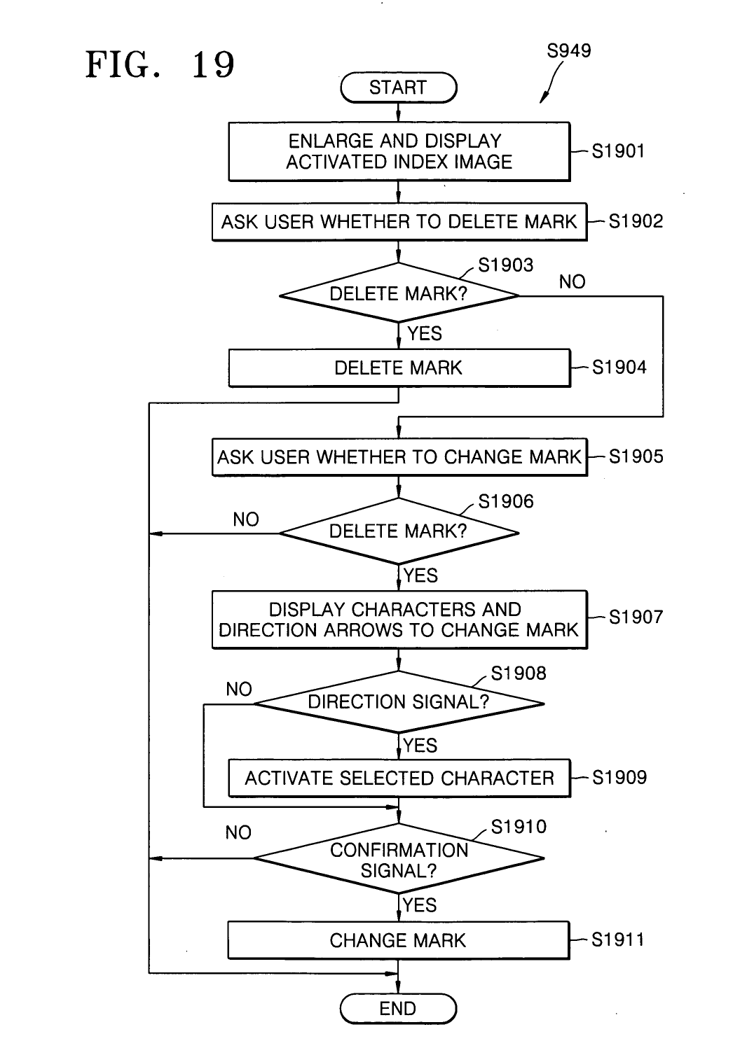

In view of the foregoing example, one can appreciate that when the camera is set in the reproducing mode (e.g., S9 of FIG. 4) that the user can filter and display only the user files having names which include a particular first character. For example, as shown in FIG. 18, only user files that have been marked with the character “C” are being displayed on the color LCD panel 35 of the digital camera 1. Accordingly, the user can easily find one or more files in the digital camera 1 itself.

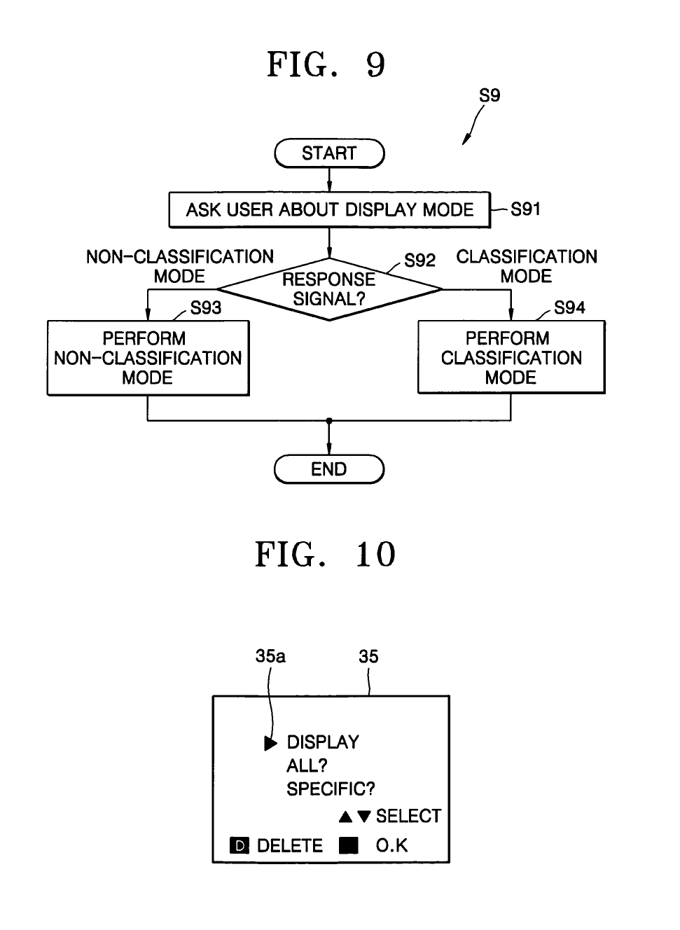

FIG. 9 is a flowchart illustrating the reproducing mode (S9) algorithm of FIG. 4. FIG. 10 is a screen displayed on the color LCD panel 35 of FIGS. 2 and 3 after performing operation S91 illustrated in FIG. 9. The reproducing mode (S9) algorithm of FIG. 4 will now be described with reference to FIGS. 1 through 3 and FIGS. 9 and 10.

The DCP 507 prompts the user to select a display mode by displaying various text and icons on the color LCD panel 35 (S91, see FIG. 10). The user moves an active arrow 35a, which is initially located to the left of the text “DISPLAY”, to the left of “ALL?” or “Specific?” using the macro/down button 15_{D} and/or the voice-memo/up button 15_{U}. Then, the user presses the menu/select-confirm button 15_{M} once (S92) and selects “ALL” to enter a non-classification mode (S93) or “Specific” to enter a classification mode (S94).

The non-classification mode is a reproducing mode in which user files are displayed according to a photographing sequence and regardless of whether a user has marked one or more of the user files, whereas the classification mode is a reproducing mode in which a subset of the user files being commonly marked are filtered from all the user files and displayed. If the user selects the non-classification mode or the classification mode, the DCP 507 performs a selected mode (S93 or S94).

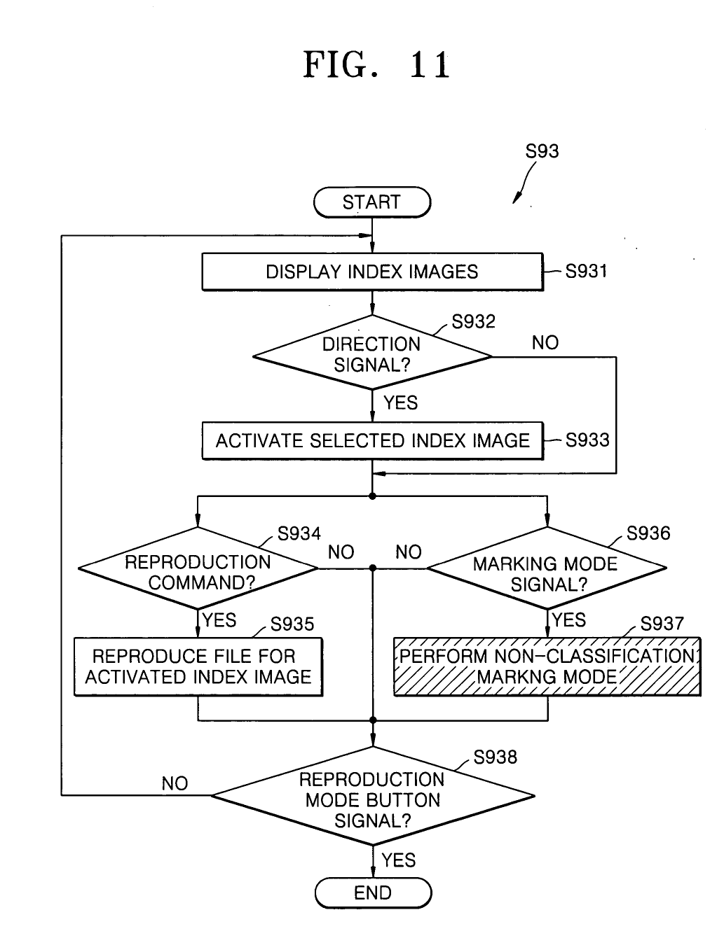

FIG. 11 is a flowchart illustrating the non-classification mode (S93) algorithm of FIG. 9. FIG. 12 is a screen displayed on the color LCD panel 35 of FIGS. 2 and 3 after performing operation S931 illustrated in FIG. 11. The non-classification mode (S93) algorithm of FIG. 9 will now be described with reference to FIGS. 1 through 3 and FIGS. 11 and 12.

As shown in FIG. 12, the DCP 507 controls the LCD driver 514 to display, for example, six index images on the color LCD panel 35 in a forward or reverse chronological order when the non-classification mode S93 is selected. As illustrated, although several of the file index images are marked with a character, all index images are displayed regardless of whether they have been marked.

If the user selects an index image using a self-timer/right button 15_{R}, the flash/left button 15_{L}, the macro/down button 15_{D}, and/or the voice-memo/up button 15_{U} (S932), the DCP 507 controls the LCD driver 514 to activate (i.e., highlight or indicate) the selected index image (S933). For example, as shown in FIG. 12, the DCP 507 and LCD driver 514 may indicate the activated index image by generating a dashed circle on the index image.

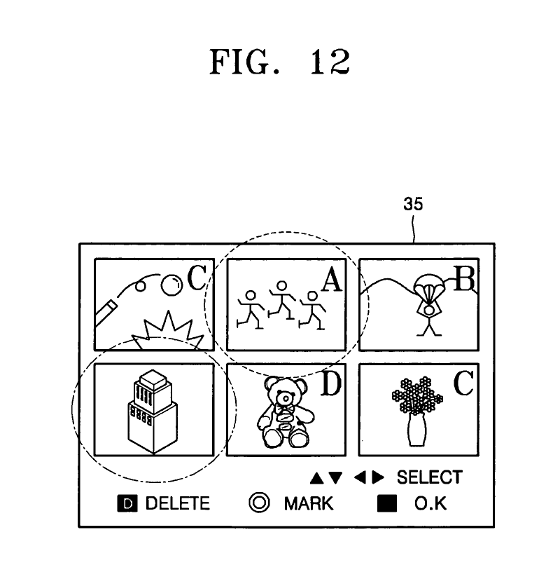

When the selected index image is activated, if the user generates a reproduction command (S934) (e.g., by pressing the menu/select-confirm button 15_{M}), the DCP 507 then reproduces a file on the full panel 35 for the activated index image (S935). If the user generates a marking-mode signal (S936) (e.g., by pressing the menu/select-confirm button 15_{M} twice in a row), the DCP 507 performs the non-classification marking mode (S937), which will be described later in detail with reference to FIGS. 13 through 16C.

Operations S931 through 937 of the reproduction mode S9 are repeated until the user presses the reproduction mode button 42 (S938) to terminate or exit the reproduction mode.

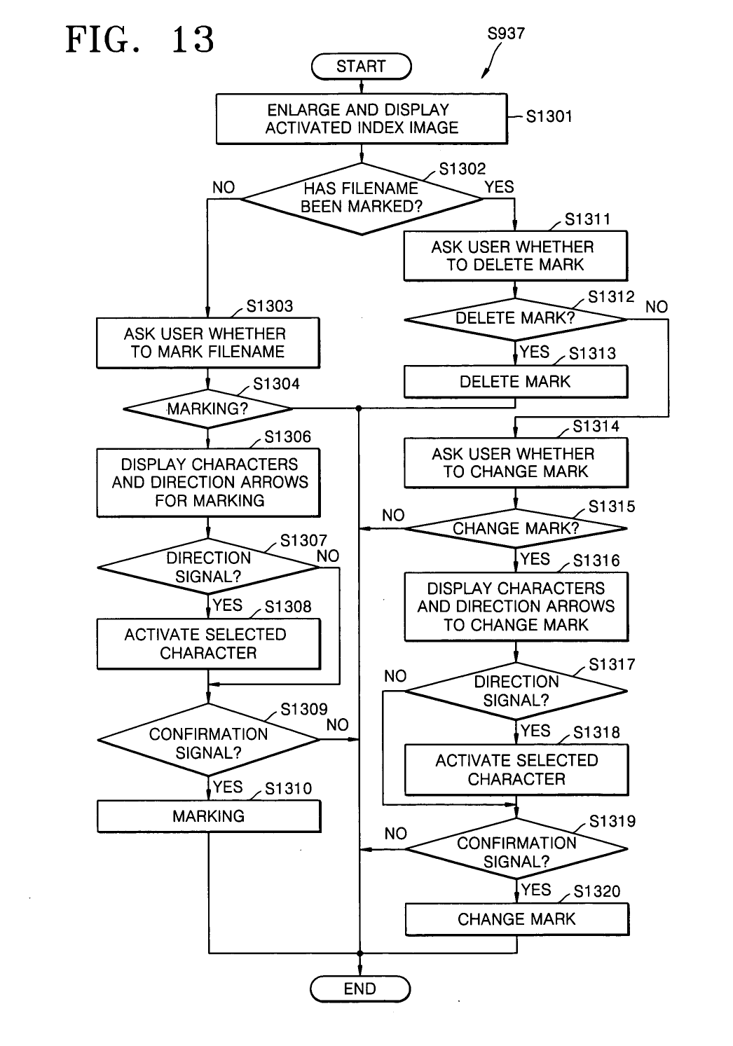

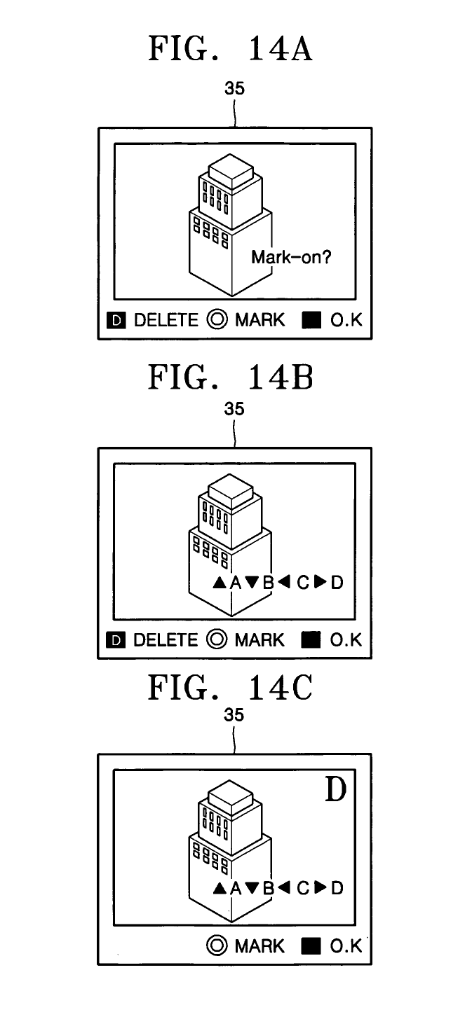

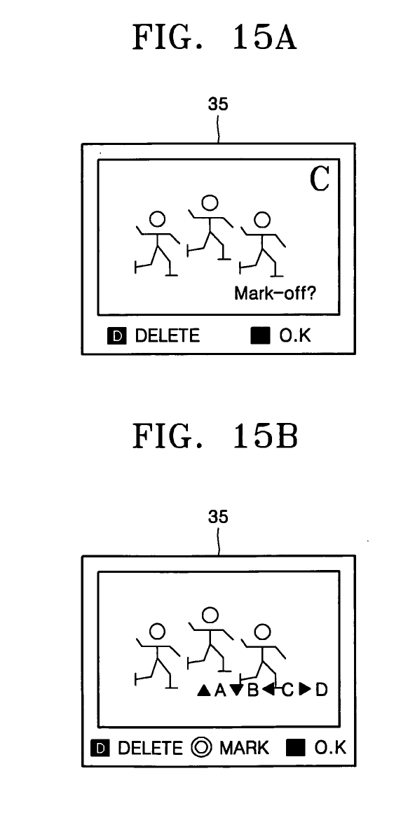

FIG. 13 is a flowchart illustrating the non-classification marking mode (S937) algorithm of FIG. 11. FIG. 14A is a screen displayed on the color LCD panel 35 as a result of performing operation S1303 of FIG. 13. FIG. 14B is a screen displayed on the color LCD panel 35 as a result of performing operation S1306 of FIG. 13. FIG. 14C is a screen displayed on the color LCD panel 35 as a result of performing operation S1310 of FIG. 13. FIG. 15A is a screen displayed on the color LCD panel 35 as a result of performing operation S1311 of FIG. 13. FIG. 15B is a screen displayed on the color LCD panel 35 as a result of performing operation S1313 of FIG. 13.

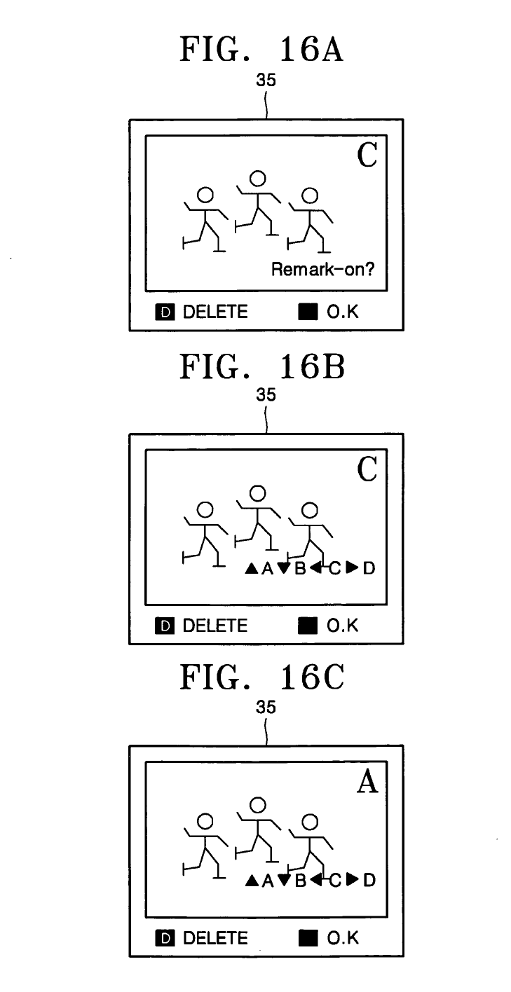

FIG. 16A is a screen displayed on the color LCD panel 35 as a result of performing operation S1314 of FIG. 13. FIG. 16B is a screen displayed on the color LCD panel 35 as a result of performing operation S1316 of FIG. 13. FIG. 16C is a screen displayed on the color LCD panel 35 as a result of performing operation S1320 of FIG. 13. The non-classification marking mode (S937) algorithm will now be described with reference to FIGS. 1 through 3 and 13 through 16C.

The DCP 507 controls the LCD driver 514 to enlarge and display the activated index image (S1301). Then, the DCP 507 determines whether the first character included in the name of a file for the enlarged index image is one of A through D (S1302). In other words, the DCP 507 determines whether the filename of the enlarged index image has been previously marked by the user. If the user has not previously marked the file name, the following operations are performed.

Through the color LCD panel 35, the DCP 507 prompts the user whether the user desires to mark the filename (S1303, see FIG. 14A). If the user generates a signal indicating that the user does not desire to mark the filename (e.g., by pressing the menu/select-confirm button 15_{M} twice in a row), the DCP 507 terminates the non-classification marking mode (S1304) and performs operation S938 of FIG. 11. Conversely, if the user generates a signal indicating that the user desires to mark the filename (e.g., by pressing the menu/select-confirm button 15_{M} only once), the following operations are performed.

The DCP 507 controls the LCD driver 514 to display on the color LCD panel 35 a predetermined subset of characters, herein A, B, C and D and direction arrows (S1306, see FIG. 14B). Referring to FIG. 14B, an upward arrow, a downward arrow, a leftward arrow, and a rightward arrow are displayed to the left of “A,” “B,” “C,” and “D,” respectively for selection thereof. If the user generates a direction signal by pressing the self-timer/right button 15_{R}, the flash/left button 15_{L}, the macro/down button 15_{D}, and/or the voice-memo/up button 15_{U} (S1307), the DCP 507 controls the LCD driver 514 to activate a character selected by the generated direction signal (S1308).

Thus, as one can appreciate, there is a one to one correspondence between the character selection (i.e., direction) buttons and the characters to facilitate user selection. Specifically, if the user presses the voice-memo/up button 15_{U}, “A” is activated, if the user presses the macro/down button 15_{D}, “B” is activated, if the user presses the flash/left button 15_{L}, “C” is activated, and if the user presses the self-timer/right button 15_{R}, “D” is activated (S1308). In this way, in a state where a character is activated, if the user generates the signal indicating that the user desires to mark the filename (S1309) (e.g., by pressing the menu/select-confirm button 15_{M} once), the DCP 507 controls the LCD driver 514 to synthesize (i.e., combine) the character with the index image and change the filename (S1310, see FIG. 14C). Referring to FIG. 14C, the character “D”, which has been synthesized with the index image, is displayed in the top-right corner of the index image.

Conversely, in operation S1309, if the user generates the signal indicating that the user does not desire to mark the filename (e.g., by pressing the menu/select-confirm button 15_{M} twice in a row), the DCP 507 terminates the non-classification marking mode (S937) and performs operation S938 of FIG. 11.

In operation S1302, if it is determined that the filename has been previously marked the following operations are performed.

Through the color LCD panel 35, the DCP 507 prompts the user (see FIG. 15A “DELETE”) whether the user desires to delete an existing mark (S1311). If the user generates a signal indicating that the user desires to delete the mark (e.g., by pressing the menu/select-confirm button 15_{M} once) (S1312), the DCP 507 controls the LCD driver 514 to delete a character (e.g., “C” in the upper right-hand corner of FIG. 15A) synthesized with the index image. The DCP 507 then restores the filename of the index image to the original name (S1313) and displays the index image without a mark (FIG. 15B).

However, in Operation S1312 if the user generates a signal indicating that the user does not desire to delete the mark (e.g., by pressing the menu/select-confirm button 15_{M} twice in a row), the DCP 507 performs the following operations, for example to change an existing mark to a different mark.

As shown in FIG. 16A, the index image has previously been marked by the user with the character “C”. Since the user has declined to delete the existing mark in Operation S1312, the DCP 507 via the color LCD panel 35 prompts the user whether the user desires to change the existing mark (S1314, see also FIG. 16A “Remark-on?”). At step S1315 if the user generates a signal indicating that the user does not desire to change the mark (e.g., by pressing the menu/select-confirm button 15_{M} twice in a row), the DCP 507 terminates the non-classification marking mode (S937) and instead performs operation S938 of FIG. 11. If the user generates a signal indicating that the user desires to change the mark (e.g., by pressing the menu/select-confirm button 15_{M} once) (S1315), the following operations are performed.

The DCP 507 controls the LCD driver 514 to display on the color LCD panel 35 the character choices for marking the file (e.g., herein “A B C D” as shown in FIG. 16B) and direction arrows associated with the character choices. Referring to FIG. 16B, an upward arrow, a downward arrow, a leftward arrow, and a rightward arrow are displayed to the left of “A”, “B”, “C” and “D”, respectively. Thus, if the user generates a direction signal (S1317) by pressing the self-timer/right button 15_{R}, the flash/left button 15_{L}, the macro/down button 15_{D}, and/or the voice-memo/up button 15_{U}, the DCP 507 controls the LCD driver 514 to activate a character selected by the generated direction signal (S1318).

Specifically, if the user presses the voice-memo/up button 15_{U}, “A” is activated, if the user presses the macro/down button 15_{D}, “B” is activated, if the user presses the flash/left button 15_{L}, “C” is activated, and if the user presses the self-timer/right button 15_{R}, “D” is activated (S1318). In this way, in a state where a character is activated, if the user generates the confirmation signal indicating that the user desires to change a mark (S1319) (e.g., by pressing the menu/select-confirm button 15_{M} once), the DCP 507 controls the LCD driver 514 to synthesize (i.e., combine) the character with the index image and change the filename (S1320, see FIG. 16C). Referring to FIG. 16C, “A,” which has been synthesized with the index image, is displayed in the top-right corner of the index image. By comparing FIG. 16C to FIG. 16A, one can appreciate that the marking character for the displayed index image and respective file name has been changed from “C” to “A”.

Conversely, in operation S1319, if the user generates the signal indicating that the user does not desire to change the mark (e.g., by pressing the menu/select-confirm button 15_{M} twice in a row), the DCP 507 terminates the non-classification marking mode (S937) and performs operation S938 of FIG. 11.

FIG. 17 is a flowchart illustrating the classification reproduction mode (S94) algorithm of FIG. 9. FIG. 18 is an example screen display of the color LCD panel 35 resulting from the operation S943 of FIG. 17. The classification marking mode (S94) algorithm of FIG. 9 will now be described with reference to FIGS. 1 through 3 and FIGS. 17 and 18.

Through the color LCD panel 35, the DCP 507 prompts the user asking which mark the user desires to select (S941) for the purpose of reproducing (i.e., displaying) only the images/files marked with that corresponding character. However, at step S942 if the user does not select a mark and instead generates a signal indicating that the user does not desire classified reproduction (e.g., by pressing the menu/select-confirm button 15_{M} twice in a row), the DCP 507 terminates the classification reproduction mode. Alternatively, if the user selects a character by pressing the self-timer/right button 15_{R}, the flash/left button 15_{L}, the macro/down button 15_{D}, and/or the voice-memo/up button 15_{U} and then activates the selected mark (e.g., by pressing the menu/select-confirm button 15_{M} once) (S942), the following operations are performed.

The DCP 507 controls the LCD driver 514 to display on the color LCD panel 35 (S943) only the index images having the selected mark. As shown in FIG. 18, all of the six displayed index images are marked with the character “C” in their upper right-hand corners. Thus the “C”-marked images are filtered out of all stored images in the camera 1 as a subset for display.

Now, if the user selects one of the displayed index images using the directional buttons (e.g., self-timer/right button 15_{R}, the flash/left button 15_{L}, the macro/down button 15_{D}, and/or the voice-memo/up button 15_{U}) in step S944, the DCP 507 controls the LCD driver 514 to activate the selected index image (S945).

Now, when the selected index image is activated, if the user generates the reproduction command (e.g., by pressing the menu/select-confirm button 15_{M}) (S946), the DCP 507 reproduces a file for the activated index image (S947). If the user generates the marking-mode signal (e.g., by pressing the menu/select-confirm button 15_{M} twice in a row) (S948), the DCP 507 performs the classification marking mode (S949). The classification marking mode will be described later in detail with reference to FIG. 9.

Operations S943 through 949 are repeated until the user presses the reproduction mode button 42 (S950) to exit the reproduction classification mode.

The classification marking mode (S949) algorithm of FIG. 17 will now be described with reference to FIG. 19. The DCP 507 controls the LCD driver 514 to enlarge and display the activated index image (S1901).

Through the color LCD panel 35, the DCP 507 prompts the user asking whether the user desires to delete a mark (S1902, see FIG. 15A). If the user generates the signal indicating that the user desires to delete the mark (e.g., by pressing the menu/select-confirm button 15_{M} once) (S1903), the DCP 507 controls the LCD driver 514 to delete a character being synthesized with the index image and restores the filename of the index image to the original name (S1904, see FIG. 15B). The DCP 507 then terminates the classification marking mode (S949) and performs operation S950 of FIG. 17.

If the user generates the signal indicating that the user does not desire to delete the mark (e.g., by pressing the menu/select-confirm button 15_{M} twice in a row) (S1903), through the color LCD panel 35, the DCP 507 prompts the user whether the user desires to change an existing mark (S1905).

At step 1906, if the user generates the signal indicating that the user does not desire to change the mark (e.g., by pressing the menu/select-confirm button 15_{M} twice), the DCP 507 then terminates the classification marking mode (S949) and performs operation S950 of FIG. 17. However, if the user generates the signal indicating that the user desires to change the mark (e.g., by pressing the menu/select-confirm button 15_{M} once), the following operations are performed.

The DCP 507 controls the LCD driver 514 to display on the color LCD panel 35 the character options (e.g., herein A B C D) for changing a mark and direction arrows (S1907, see FIG. 16B). Referring to FIG. 16B, an upward arrow, a downward arrow, a leftward arrow, and a rightward arrow are displayed to the left of “A”, “B”, “C” and “D,” respectively. If the user generates a direction signal by pressing the self-timer/right button 15_{R}, the flash/left button 15_{L}, the macro/down button 15_{D}, and/or the voice-memo/up button 15_{U} (S1908), the DCP 507 controls the LCD driver 514 to activate a character selected by the generated direction signal (S1909).

Specifically, if the user presses the voice-memo/up button 15_{U}, “A” is activated, if the user presses the macro/down button 15_{D}, “B” is activated, if the user presses the flash/left button 15_{L}, “C” is activated, and if the user presses the self-timer/right button 15_{R}, “D” is activated (S1318). In this way when a character is activated, if the user generates the signal indicating that the user desires to change a mark (e.g., by pressing the menu/select-confirm button 15_{M} once) (S1910), the DCP 507 controls the LCD driver 514 to synthesize the character with the index image and change the filename (S1911, see FIG. 16C). Referring to FIG. 16C, “A,” which has been synthesized with the index image, is displayed in the top-right corner of the index image.

Conversely, in operation S1910, if the user generates the signal indicating that the user does not desire to change the mark (e.g., by pressing the menu/select-confirm button 15_{M} twice in a row), the DCP 507 terminates the classification marking mode (S949) and performs operation S950 of FIG. 17.

As described above, according to a method of controlling a digital photographing apparatus and a digital photographing apparatus using the method, a user can easily classify and store user files using particular characters and display only the classified and stored user files. Accordingly, the user can easily find a file in the digital photographing apparatus itself.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for classifying a user file including a unique file name stored in a digital photographing apparatus, the method comprising:
reproducing the user file on a display screen;
displaying on the display screen user-selectable indicia for association with the user file of the reproducing step;
receiving a user-actuated signal according to a selected indicium; and
synthesizing the indicium with the user file.

2. The method of claim 1 wherein the unique file name comprises a plurality of alphanumeric characters.

3. The method of claim 2 wherein the synthesizing step comprises modifying the unique alphanumeric file name according to the indicium.

4. The method of claim 3 wherein the modifying step comprises substituting the indicium for one of the plurality of alphanumeric characters.

5. The method of claim 1 wherein the user file comprises a still image file including image data.

6. The method of claim 5 wherein the indicium comprises an alphanumeric character.

7. The method of claim 6 wherein the synthesizing step comprises:
displaying a still image relative to the image data;
displaying the alphanumeric character on the still image; and
modifying the unique file name with the alphanumeric character.

8. The method of claim 7 wherein the modifying step comprises substituting the alphanumeric character for a first character of the unique file name.

9. A method for displaying a subset of image files saved in a storage medium of a digital photographing apparatus, the storage medium including a plurality of image files, the method comprising:
displaying a plurality of image files stored in the storage medium on a display screen;
marking each image file of the plurality according to a marking signal relative to an indicium selected by a user from an indicia menu on the display screen;
receiving a display signal relative to an indicium of interest selected by the user; and
filtering the image files marked with the indicium of interest from the plurality of image files for display on the display screen in an index image format.

10. The method of claim 9 wherein the indicia menu comprises a predetermined number of indicium.

11. The method of claim 10 wherein the predetermined number comprises four.

12. The method of claim 10 wherein the indicia menu comprises the alphanumeric characters A, B, C and D.

13. The method of claim 9 wherein the marking step comprises synthesizing the image file with the indicium.

14. The method of claim 13 wherein the synthesizing step comprises:
displaying a still image relative to image data in an image file;
displaying the indicium on the still image; and
modifying a file name of the image file relative to the indicium selected from the indicia menu.

15. The method of claim 14 wherein the modifying step comprises appending the indicium to a start of the file name.

16. The method of claim 14 wherein the modifying step comprises substituting the indicium for a first character of the file name.

17. A digital photographing apparatus that classifies user files, the apparatus comprising:
a user input including a mode dial, a directional button and a confirmation button;
a storage medium including a plurality of user files in a chronological file hierarchy;
a display for reproducing the plurality of user files from the storage medium; and
a processor subsystem linked with the user input, the storage medium and the display, wherein the processor subsystem retrieves a user file from the storage medium according to a user-actuated signal from the directional and confirmation buttons and readies said user file for modification, drives the display to provide a marking menu for marking the user file being activated with an indicium, and synthesizes the user file being activated with the user-selected indicium of the marking menu.

18. The digital photographing apparatus of claim 17 wherein the processor subsystem comprises:
a micro-controller linked with the user input for receiving a mode signal from the mode dial, a selection signal from the direction button and a confirmation signal from the confirmation button; and
a digital signal processor in communication with the micro-controller and linked with storage medium and the display for generating an image on the display for a user file according to the selection signal and the confirmation signal.

19. The digital photographing apparatus of claim 18 further comprising a user file name-changing means in communication with the digital signal processor for modifying a name of the user file being activated relative to the indicium.

20. The digital photographing apparatus of claim 19 further comprising a user file data-changing means in communication with the digital signal processor for modifying an image data of the user file being activated so that the user file is reproduced on the display with the indicium.
